(19) United States
(12) Patent Application Publication
(10) Pub. No.: US 2013/0143040 A1
(43) Pub. Date: Jun. 6, 2013

(54) Self-Illuminating Reflective Sticker

(71) Applicants: Zachary Green, Cincinnati, OH (US); Joseph Bloomfield, Brea, CA (US)

(72) Inventors: Zachary Green, Cincinnati, OH (US); Joseph Bloomfield, Brea, CA (US)

(21) Appl. No.: 13/672,196

(22) Filed: Nov. 8, 2012

Related U.S. Application Data
(60) Provisional application No. 61/557,988, filed on Nov. 10, 2011.

(51) Int. Cl. G09F 3/00

(52) U.S. Cl. CPC G09F 3/0294
USPC 428/354

(57) ABSTRACT

A self-illuminating reflective sticker includes a fire-resistant backing layer, an effective amount of a photoluminescent layer that is blended with a pigment, a prismatic film that is permanently attached to the fire-resistant backing layer, and an adhesive layer.

### CROSS-REFERENCE TO RELATED APPLICATIONS

This application claims the benefit of the filing date of U.S. Provisional Application Ser. No. 61/557,988, filed Nov. 10, 2011.

### BACKGROUND

Environments having low visible light often lead to low visibility conditions. The low visibility conditions may decrease mobility of individuals attempting to leave the environment or individuals, for example firefighters, who must perform tasks in the environment. Moreover, identification of such individuals in low visibility conditions may be impaired even when reflective materials are used as the lack of visible light renders the reflectors inoperable.

Moreover, methods of illuminating such environments typically include electrical lights. However, such electrical lights require a power source. Both the electrical light and the power source are prone to failure in adverse environmental conditions. When such power sources fail, reflective materials are rendered ineffective. Accordingly, self-illuminating reflective stickers that provide light without a power source are desired.

### SUMMARY

Self-illuminating reflective stickers according to the present disclosure allow for the generation of visible light in a wavelength that differs from the wavelength of the photoluminescent material incorporated into the sticker. The self-illuminating reflective stickers include a prismatic film that reflects visible light that is directed on the external facing surface of the sticker, and allows the transmission of visible light through the prismatic film. The self-illuminating reflective stickers include an adhesive layer that allows for the self-illuminating reflective stickers to be attached to surfaces.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a top view of a self-illuminated sticker according to one or more embodiment shown and described herein; and

FIG. 2 depicts a sectional side view of the self-illuminated sticker shown along line A-A of FIG. 1.

### DETAILED DESCRIPTION

Embodiments described herein relate to self-illuminated reflective stickers that provide light without requiring a power source. The self-illuminating reflective stickers are formed in layers and include a fire-resistant backing layer, a photoluminescent layer that includes an effective amount of photoluminescent material that is blended with a pigment, a prismatic film that is permanently attached to the fire-resistant backing layer and an adhesive layer. The photoluminescent layer allows the self-illuminating reflective stickers to produce visible light without connection to a power source.

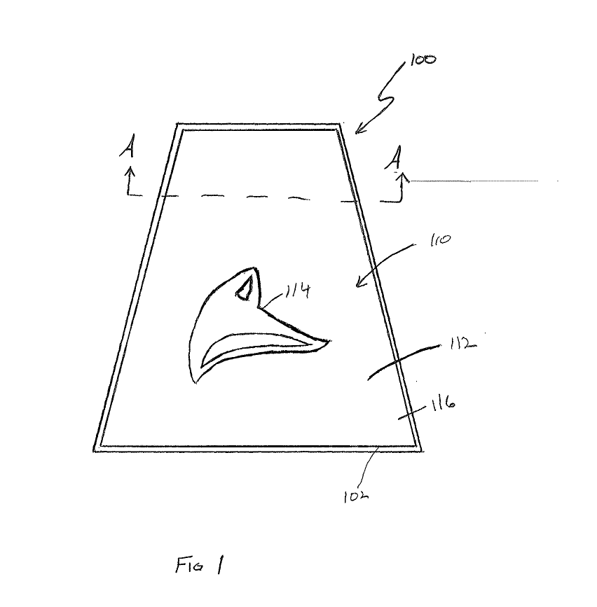

Referring to FIG. 1, a self-illuminating reflective sticker 100 is depicted. The external-facing surface 116 of the self-illuminating reflective sticker 100 is a prismatic film 110 that reflects visible light that is directed onto the external facing surface 116. The prismatic film 110 also allows visible light to be transmitted through the prismatic film 110 itself through the internal-facing surface. One prismatic film 110 suitable for the envisioned applications is Brilliance Series Flame Resistant film available from Reflexite Americas of New Britain, Conn. However, it should be understood that other, similar film materials may also be used.

The prismatic film 110 may include an embossed or debossed portion 114 that is continuous with the external-facing surface 116 of the prismatic film 110. The embossed or debossed portion 114 may be formed into the prismatic film 110 in a shape that corresponds to a brand mark of the manufacturer or similar identifying indicia. Additionally, letters and geometric shapes can be embossed or debossed in the prismatic film 110.

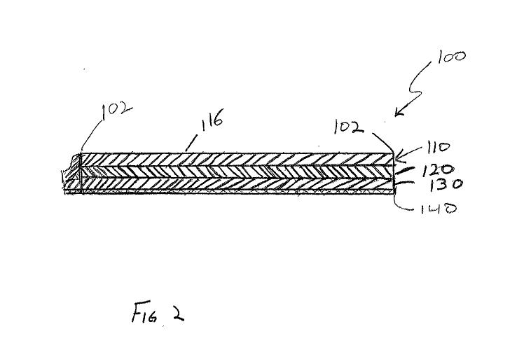

Referring now to FIG. 2, the self-illuminating reflective sticker 100 is constructed such that the prismatic film 110 is attached to a backing layer 130. The backing layer 130 is constructed of a fire-retardant material, examples of which include, Nomex®, Kevlar®, or cotton fabric that is treated with a fire-resistant coating. However, it should be understood that other fire retardant materials may be used.

Still referring to FIG. 2, a photoluminescent layer 120 is positioned between the prismatic film 110 and the backing layer 130. The photoluminescent layer 120 includes a mixture of powdered photoluminescent material and pigment held in suspension. In some embodiments, the photoluminescent powder is strontium aluminate which is available commercially. The strontium aluminate powder produces visible light in a narrow band of wavelengths, thereby limiting the number of colors that can readily be produced. The addition of pigment to the photoluminescent layer 120 allows the photoluminescent material to excite the pigment. As such, the self-illuminating reflective sticker 100 produces light in a wavelength that does not correspond to the wavelength of the strontium aluminate, instead producing light in a color closer to that of the pigment.

The strontium aluminate and the pigment are held in suspension in a carrier. In one embodiment, the carrier is a plastisol, or a suspension of PVC particles in a plasticizer. Holding the mixture of the strontium aluminate and the pigment in the carrier allows for an even mixture of the components, and eases application of the photoluminescent layer 120 to the components of the self-illuminating reflective sticker 100. The photoluminescent material may be held in the carrier at a ratio from about 10% to about 60% strontium aluminate by weight with the balance being pigment and plastisol.

Suitable materials utilized in the photoluminescent layer 120 include those materials described in U.S. Pat. No. 6,177,029, issued Jan. 23, 2001, and U.S. Pat. No. 7,507,352, issued Mar. 24, 2009, both of which are incorporated herein by reference. However, it should be understood that other materials may also be used in addition or substitution to these materials.

The photoluminescent layer 120 may be applied to one or more of the prismatic film 110 or the backing layer 130. The photoluminescent layer 120 may be applied in a pressure lamination operation or an adhesive lamination operation. The photoluminescent layer 120 may be applied at a thickness from about 0.010 to 0.020 inch. With the photoluminescent layer 120 applied, the prismatic film 110, the photoluminescent layer 120, and the backing layer 130 may be assembled into a layered structure and permanently affixed to one another using a radio frequency weld joint 102. Before or after affixing the layers of the self-illuminating reflective sticker 100, an adhesive layer 140 is applied to the backing layer 130 on the side opposite the photoluminescent layer 120. The adhesive layer 140 may be a pressure-sensitive adhesive. For applications where elevated temperatures are likely to be experienced, the adhesive layer 140 may be formulated to resist peeling of the self-illuminating reflective sticker 100 when heated.

It should now be understood that self-illuminating reflective stickers according to the present disclosure allow for the generation of visible light in a wavelength that differs from the wavelength of the photoluminescent material. The self-illuminating reflective stickers include a prismatic film that reflects visible light that is directed to the external facing surface, and allows transmission of visible light through the prismatic film. The self-illuminating reflective stickers include an adhesive layer that allows for the self-illuminating reflective stickers to be attached to non-compliant surfaces.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A self-illuminating reflective sticker comprising:
a backing layer comprising a fire-resistant material;
a prismatic film at least partially sealed to the backing layer;
an adhesive layer coupled to the backing layer and positioned opposite the prismatic film; and
a photo luminescent layer applied to at least one of the backing layer or the prismatic film, the photoluminescent layer adapted to absorb energy and emit light at a visible wavelength.

2. A method of illuminating a sticker as shown or described in the figures or specification.

3. A method for forming a self-illuminating reflective sticker as shown or described in the figures or specification.
